(19) United States
(12) Patent Application Publication
(10) Pub. No.: US 2010/0257440 A1
(43) Pub. Date: Oct. 7, 2010

(54) HIGH PRECISION WEB EXTRACTION USING SITE KNOWLEDGE

(76) Inventors: Meghana Kshirsagar, Pune (IN); Rajeev Rastogi, Bangalore (IN); Sandeepkumar Bhuramal Satpal, Bangalore (IN); Srinivasan H. Sengamedu, Bangalore (IN); Venu Satuluri, Colombus, OH (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/416,381

(22) Filed: Apr. 1, 2009

(51) Int. Cl. G06F 17/21; G06F 17/00

(52) U.S. Cl. 715/230; 715/256

(57) ABSTRACT

Techniques for high precision web extraction using site knowledge are provided. Portions of repeating text are identified in unlabeled web pages from a particular web site. Based on the portions of repeating text, the unlabeled web pages are partitioned into a set of segments. Multiple labels are assigned to respectively corresponding multiple attributes in the set of segments, where assigning the multiple labels comprises applying a classification model to each separate segment in the set of segments. First one or more labels are identified that were erroneously assigned to one or more attributes in the set of segments. Second one or more correct labels for the one or more attributes are determined. The first one or more labels in the set of segments are corrected by assigning the second one or more labels to the one or more attributes.

### FIELD OF THE INVENTION

The present invention relates to processing information and, in particular, to extracting information from electronic documents.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Extracting structured records from semi-structured web pages belonging to tens of thousands of web sites has a number of applications and uses, which may include improving web search results, quality, web integration information, etc. Typically, a web page in a web site would include a variety of detailed information that may be of interest to a user. For example, a page from an aggregator web site that provides restaurant reviews may include details like restaurant names, restaurant categories, addresses, phone numbers, hours of operation, user reviews, etc. Since such detailed information is included in web pages that are semi-structured, any information extraction approach inevitably faces the problem of how to efficiently extract such detailed information from the web pages and store the extracted data into structured records that include one or more fields.

Some existing web information extraction approaches are based on wrapper induction, which requires a large amount of editorial effort for annotating pages. The wrapper induction approaches rely on human users to annotate a few sample web pages from each web site, and through the annotations, to specify the locations of attribute values on each web page. Thereafter, the wrapper induction approaches utilize the annotations to learn wrappers, which are essentially extraction rules (e.g., XPath expressions) that capture the location of each attribute in the web page. One major disadvantage of the wrapper induction approaches is that they are very expensive in terms of the human user involvement that is required. Since page templates invariably change from one web site to another, wrappers learned from the web pages of one web site are typically incapable of performing extractions on web pages from a different web site. Consequently, the wrapper induction approaches require human users to provide a separate set of annotations for each web site, which becomes prohibitively expensive when structured records need to be extracted from tens of thousands of web sites.

Other existing web information extraction approaches use Conditional Random Fields (CRF) models to label attribute values that are included in the web pages. Traditional CRF-based approaches overcome some of the disadvantages of the wrapper induction approaches since they rely not only on page structure but also on the content of the page attributes. However, the traditional CRF-based approaches introduce some drawbacks of their own. For example, the traditional CRF-based approaches require a large number of training examples in order to produce accurate attribute labeling for a large number of web sites that have very diverse structures. Furthermore, the web pages in any given web site typically contain a lot of noise (e.g., information that is not of interest and need not be extracted), which hurts the precision of the traditional CRF-based approaches in extracting structured records from such web pages.

### BRIEF DESCRIPTION OF THE DRAWINGS

In the figures of the accompanying drawings like reference numerals refer to similar elements.

FIG. 1A depicts an example web page from an aggregator web site, where the web page includes detailed restaurant information that may be of interest to a user.

FIG. 1B is a block diagram that illustrates a data structure which may be used to store the detailed restaurant information depicted in FIG. 1A.

FIG. 2 is a flow diagram that illustrates a method for high precision web extraction according to an example embodiment.

FIG. 3 is block diagram that illustrates a simplified HTML code fragment for a portion of the web page depicted in FIG. 1A.

FIG. 4A is a block diagram that illustrates a training phase of a method for high precision web extraction according to an example embodiment.

FIG. 4B is a block diagram that illustrates a labeling phase of a method for high precision web extraction according to an example embodiment.

FIG. 5 is a block diagram that illustrates an example computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques for high precision web extraction using site knowledge are described. The techniques exploit site knowledge to achieve high precision while requiring only very few web pages to be annotated by human users. As used herein, “web page” refers to an electronic document that is stored in, or can be otherwise provided by, a web site. A web page may be stored as a file or as any other suitable persistent and/or dynamic structure that is operable to store an electronic document or a collection of electronic documents. Typically, web pages can be rendered by a browser application program and can also be accessed, retrieved, and/or indexed by other programs such as search engines and web crawlers. The techniques described herein are used to precisely extract attributes from semi-structured web pages using site knowledge. As used herein, “attribute” refers to a content value in a web page. When extracted from a web page, an attribute or a grouping of related attributes may be stored as a record in a suitable data structure such as, for example, a table in a database or other data repository.

According to the techniques described herein, portions of repeating text are identified in unlabeled web pages from a particular web site. Based on the portions of repeating text, the unlabeled web pages are partitioned into a set of segments. Multiple labels are assigned to respectively corresponding multiple attributes in the set of segments, where assigning the multiple labels comprises applying a classification model to each separate segment in the set of segments. Any labels, which are erroneously assigned to one or more attributes in the set of segments, are identified and correct labels for the one or more attributes are determined. The erroneously assigned labels are then corrected by assigning the correct labels to the one or more attributes.

The techniques described herein may use any machine-learning classification model, such as CRF models, that may be trained to label attributes in web pages. To determine the parameter values of a classification model, the techniques described herein provide for constructing a training set of pages by selecting a small sample of web pages from a few initial web sites. User input is then received, where the user input annotates the attributes in the sample web pages that are of interest to a user. Wrappers are learned from the sample web pages; the wrappers are thereafter used to label attributes in the remaining web pages of each of the few initially chosen web sites. The classification model and the parameter values thereof are then determined based on the training set of pages.

However, unlike traditional CRF-based approaches which apply CRF models on web pages in their entirety, the techniques described herein apply a learned classification model on a set of segments into which the web pages have been partitioned and not the entire web pages themselves. Further, unlike traditional CRF-based approaches, the techniques described herein augment the application of the learned classification model to unlabeled, un-annotated web pages with pre-processing steps and post-processing steps that exploit site knowledge to boost prediction accuracy. (As used herein, “pre-processing steps” refer to steps that are performed prior to applying a classification model to unlabeled web pages from a particular web site, and “post-processing steps” refer to steps performed after the classification model is applied to label attributes in the unlabeled web pages.)

The pre-processing steps include identifying portions of repeating text and partitioning the unlabeled web pages into a set of short segments. In the pre-processing steps, site knowledge is used to accurately identify the repeating text. The post-processing steps are performed after the classification model is applied to label the attributes in the unlabeled web pages. The post-processing steps include identifying any labels that are erroneously assigned to one or more attributes, determining the correct labels for the one or more attributes, and correcting the erroneously assigned labels by replacing them with the correct labels. The site knowledge used in the post-processing steps may be in the form of in intra-page and/or inter-page constraints that are determined from the unlabeled web pages. The intra-page constraints may be used in identifying any erroneously assigned labels; the intra-page constraints may include, for example, attribute uniqueness and proximity relationships among a group of related attributes. The inter-page constraints may be used to determine the correct labels and correct the erroneously assigned labels; the inter-page constraints may include, for example, any structural similarities among the unlabeled web pages being processed. In this manner, the usage of site knowledge in both the pre-processing steps and the post-processing steps is completely unsupervised. “Unsupervised” means that a human user does not need to provide any input or to otherwise indicate anything when unlabeled web pages are being processed based on site knowledge.

The techniques for high precision web extraction described herein incur very low overhead with respect to user involvement. The techniques described herein require only a small number of sample pages belonging to a few web sites to be annotated by a human user when a training set is being constructed for the purpose of deriving a classification model. Thus, according to the techniques described herein, a human user needs to tag the attributes of interest only on a few (e.g., one or two) web pages from a few initial web sites, and thereafter the attributes of interest can be accurately extracted from web pages in other web sites in a completely unsupervised manner. This is in contrast to the traditional web extraction approaches in which human users need to annotate every attribute of interest in every web page of any web site from which information needs to be extracted.

### Example Operation Context

The techniques for high precision web extraction described herein address the problem of how to efficiently extract structured records from semi-structured web pages that may potentially belong to tens of thousands of web sites.

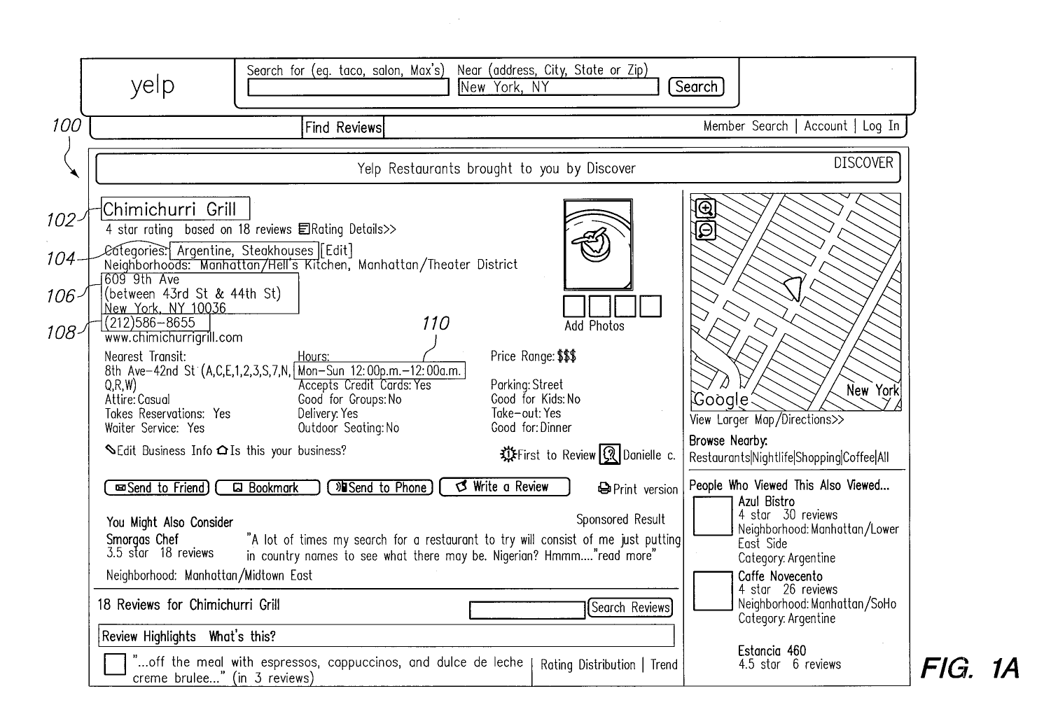

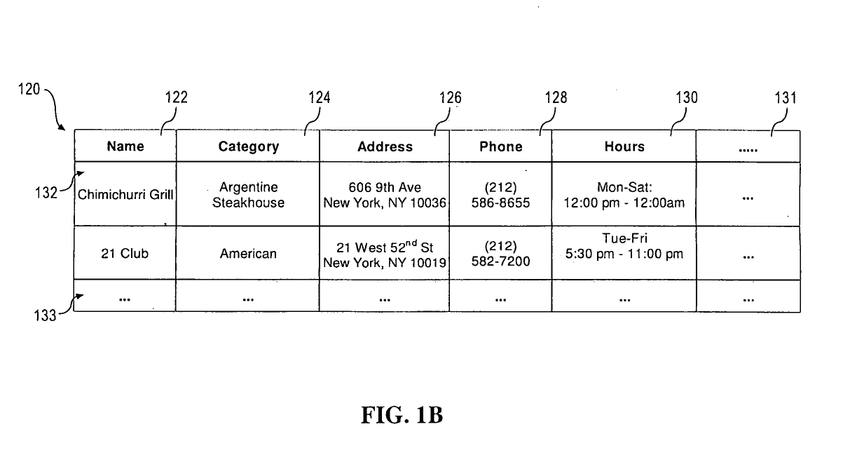

FIG. 1A depicts an example web page from the aggregator web site www.yelp.com. Web page 100 includes a wealth of information for a restaurant named “Chimichurri Grill.” From the information in web page 100, the detailed information that may be of interest to a user may include restaurant name 102, restaurant category 104, address 106, telephone number 108, and hours of operation 110. The techniques described herein provide for precisely and automatically extracting this detailed information from web page 100, and for storing the extracted data as attributes of a record in a suitable data structure.

FIG. 1B is a block diagram that illustrates a table 120 which may be used to store the detailed restaurant information depicted in FIG. 1A. Table 120 may include one or more fields for storing various attributes related to restaurants. For example, field 122 may be designated for storing a restaurant name, field 124 may be designated for storing a restaurant category, field 126 may be designated for storing an address, field 128 may be designated for storing a telephone number, and field 130 may be designated for storing a restaurant's hours of operation. (Ellipsis 131 indicates that table 120 may include more fields for storing other restaurant attributes.) In operation, table 120 may store multiple rows as indicated by ellipsis 133, where each row represents one record that includes attributes stored in one or more of fields 122-130. For example, as illustrated in FIG. 1B, table 120 may store a row representing record 132 that includes the detailed information for the “Chimichurri Grill” restaurant illustrated in web page 100 of FIG. 1A. It is noted that the web extraction techniques described herein allow for storing separate table rows that represent records for many restaurants, where the attributes for the different restaurants may be extracted from thousands of different web pages that may belong to hundreds, if not thousands, of different web sites.

It is also noted that table 120 of FIG. 1B is provided as merely an example of a data structure that may store structured records with attributes that are extracted from semi-structured web pages. The techniques described herein are not limited to being used in conjunction with tables, but may be used in conjunction with any suitable data structure that is operable to store structured records; examples of such structures include, without limitation, relational tables in relational or object-relational databases, data objects instantiated from object classes in object databases, files maintained in a file system, and a wide variety of other data structures (e.g., arrays, lists, queues, etc.) that may be maintained in volatile memory or in persistent data repositories.

The techniques described herein may be used to extract data from a wide variety of semi-structured web pages. For example, a significant fraction of existing web pages belong to web sites that use automated scripts to dynamically populate pages from back-end database management systems (DBMS). Such web sites may have thousands or even millions of web pages with fixed templates and very similar structure. An experimental study on a crawled repository of 2 billion web pages determined that over 30% of pages occur in clusters of size greater than 100 with pages in each cluster sharing a common template. Thus, template-based web pages constitute a sizeable portion of the web, and the techniques for high precision web extraction described herein focus on extracting records from such pages.

Extracting records from web pages has a number of applications which include improving the quality of web search results, web information integration, etc. For example, if a user were to type a restaurant search query, then rank ordering the restaurant pages in the search result in increasing order of distance from the user's location will greatly enhance the user experience. Enabling this requires an accurate extraction of addresses from restaurant web pages. Furthermore, integrating information extracted from different products' web sites can enable applications like comparison shopping, where users are presented with a single list of products ordered by price. An integrated database of records that store extracted data can also be accessed via database-like queries to obtain the integrated list of product features and the collated set of product reviews from the various web sites.

In an example embodiment, the techniques described herein may be implemented in an end-to-end system designed for high precision web information extraction. In accordance with the techniques described herein, the system requires only a few web pages to be annotated by human users and thus incurs low overhead.

In an example embodiment, the techniques described herein may provide for pre-processing unlabeled web pages to filter noise and segment them into shorter sequences using static repeating text across the pages of a web site.

In an example embodiment, the techniques described herein may provide for post-processing the segment labels assigned by any generic classifier (e.g., a CRF-based classification model). Accuracy is boosted by enforcing uniqueness constraints and exploiting proximity relationships among attributes to resolve multiple occurrences in a web page. The problem of selecting attribute labels that are closest to each other is NP-hard, and for this reason a heuristic may be used for attribute selection. The techniques described herein also exploit the structural similarity of pages in order to find and fix incorrect label values. To deal with structural variations among pages (e.g., due to missing attribute values), the idea of edit distance is employed to align labels across pages, and to set each label to the majority label for the location.

In an example embodiment, the efficacy of the techniques described herein has been demonstrated by using a CRF model as the underlying classifier. This embodiment has been used to conduct an extensive experimental study with real-life restaurant pages to compare the performance of the techniques described herein with the performance of a baseline CRF-based extraction. The results in this embodiment indicate that the pre-processing steps of the techniques described herein improve accuracy by a factor of 4 compared to the baseline CRF-based extraction; when the post-processing steps of the techniques described herein are performed, a further accuracy gain of 40% is achieved.

### Functional Description of an Example Embodiment

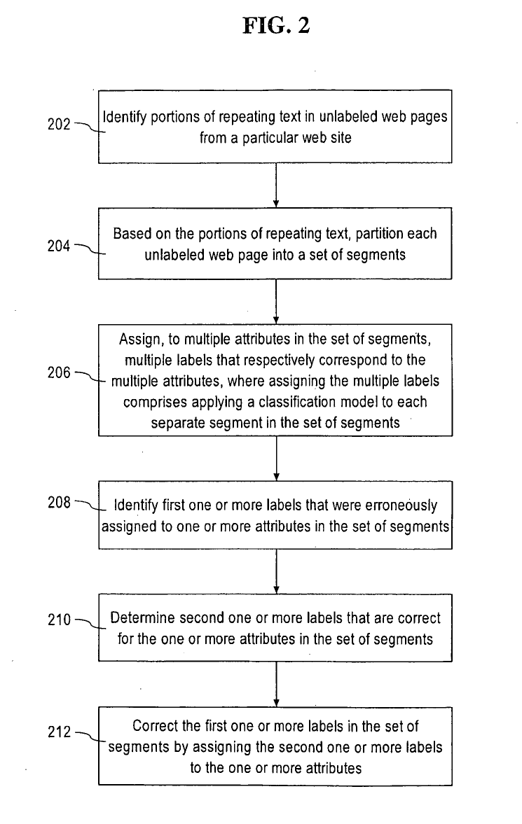

FIG. 2 is a flow diagram that illustrates a method for high precision web extraction according to an example embodiment.

In step 202, portions of repeating text are indentified in unlabeled web pages from a particular web site. As used herein, “unlabeled web page” refers to a web page which has not been annotated by a user to indicate page regions of interest and from which information is to be extracted. To identify repeating text in the unlabeled web pages, corresponding static nodes in the DOM representations of the web pages are determined. The static nodes are then assigned unique identifiers, where a node identifier for a static node may include the text content of the node and an XPath expression that identifies the location of the node within at least one of the unlabeled web pages. Each of the unlabeled web pages is then partitioned based on the assigned static node identifiers.

In step 204, each unlabeled web page is partitioned into segments based on the identified portions of repeating text. As used herein, “segment” refers to a portion of a web page that is less than the entire page. For example, a particular web page may be partitioned based on one or more static nodes identified in that page, where the page portion between any two consecutive static nodes is identified as a separate segment.

In step 206, multiple labels are assigned to respectively corresponding multiple attributes in a set of segments, where the set of segments includes the segments into which each unlabeled web page is partitioned. Assigning the multiple labels comprises applying a classification model to each separate segment in the set of segments. As used herein, “label” refers to a data value that is used to identify an attribute in one or more page segments.

A classification model may be determined during a training phase in which a training set of annotated web pages are used to determine a set of parameter values that comprise the model. As used herein, “annotated web page” refers to a web page which has been annotated, by a user and/or by some automatic mechanism, to indicate page regions of interest. The set of training web pages, from which a classification model is derived, may be annotated by a user or may be derived from user annotated pages by applying a wrapper induction technique to a larger set of pages. For example, user input may be received that annotates one or more nodes of one or two web pages from a set of web pages. Thereafter, the annotations in the user input may be used to apply a wrapper induction technique in order to label the entire set of pages; thereafter, this set of labeled pages is used as a training set in order to determine the parameters of the classification model.

In step 208, one or more labels are identified that were erroneously assigned to one or more attributes in the set of segments. Identifying the erroneously assigned labels may be performed based on intra-page constraints that may include at least one of attribute uniqueness and a proximity relationship among a group of attributes.

In step 210, one or more correct labels for the one or more attributes are determined. Determining the correct labels may be performed based on inter-page constraints (e.g., a structural similarity among the unlabeled web pages from which the set of segments is partitioned off). For example, a minimal sequence of edit operations may be determined for a group of segments that have the same segment identifier, where the sequence of edit operations is such that applying the operations in the sequence to one segment would match the structure of that segment to the structure of another segment. After the minimal sequence of edit operations has been determined, a majority operation is performed based on the minimal sequence to determine which attribute label is correct for a particular attribute within the group of segments.

In step 212, labels that were identified as erroneously assigned to attributes in the set of segments are corrected by assigning the correct labels determined for these attributes. After any erroneously assigned labels are corrected, the labeled attributes are extracted from the underlying web pages and stored as structured records in suitable computer data storage. For example, the extracted records may be persistently stored in a data repository such as, for example, a relational or object-relational database. In another example, the extracted records may be stored in one or more logical data structures in dynamic memory in order to facilitate further processing based on the extracted attributes.

The techniques for high precision web extraction based on site knowledge described herein may be performed by a variety of software components and in a variety of operational contexts. For example, in one operational context, the steps of the method illustrated in FIG. 2 may be performed by one or more modules of a search engine that is operable to retrieve or otherwise traverse web sites hosted on a wide-area network such as the Internet or on a local network such as a corporate intranet. The search engine may include, in one or more modules, logic in the form of a set of executable instructions which, when executed by one or more processors, are operable to perform the functionalities for high precision web extraction described herein. For example, in accordance with the techniques described herein, the logic may be operable to extract attributes from unlabeled web pages that have been located and indexed by other modules of the search engine, such as a web crawler and/or an indexing component.

In some operational contexts, the techniques described herein and, in particular, the steps of the method illustrated in FIG. 2 may be performed by logic that is included in the form of executable instructions in a standalone software application or in the client and/or server component of a client-server application. In various embodiments any logic operable to perform the techniques described herein in general, and the steps of the method illustrated in FIG. 2 in particular, may be implemented as components of various types including, without limitation, as one or more software modules, as one or more libraries of functions, as one or more dynamically linked libraries, as one or more active X controls, and as one or more browser plug-ins. Thus, the techniques for high precision web extraction described herein may be performed by a variety of software components and in a variety of operational contexts, and are not limited to being implemented and/or performed by any particular type of software component or in any particular operational context.

### Example Processing Model

In one embodiment, the techniques described herein are implemented to extract attributes from web sites belonging to a single vertical or category, e.g., such as restaurants. As used herein after, W denotes the set of web sites belonging to the vertical of interest, and the attributes for the vertical are denoted by A₁, . . . , Aₘ. Each web site W ε W (i.e., each web site W which belongs to the set of web sites W), includes a set of detail web pages from each of which a single record is extracted. In addition to attributes, web pages contain plenty of noise which is denoted using the special attribute A₀. (As used herein, “noise” refers to information that is not of interest and need not be extracted from a web page.) Certain attributes like restaurant name, address, and phone number have a unique contiguous value in a web page and thus satisfy a uniqueness constraint. Other attributes, such as user reviews, may have multiple non-contiguous occurrences in a web page and thus do not satisfy the uniqueness constraint. Generally, attributes appear close together in a detail web page.

In this embodiment, a processing model assumes that most of the web pages in a site are script-generated, and hence for the most part conform to a fixed template. For certain large web sites like www.amazon.com, there may be many different scripts that generate pages with different structures. In such a scenario, the techniques described herein may be used to treat each cluster of pages with similar structure as a separate web site. It is noted that the web pages in a web site have similar but not identical structure. The structural variations between web pages in the same web site arise primarily due to missing attribute values. Across web sites, however, the structure of web pages can be quite dissimilar.

According to the processing model in this embodiment, each web page is modeled as a sequence of words obtained as a result of concatenating the text in the leaf nodes of the page's DOM tree (in the order in which they appear in the tree). When convenient for processing purposes, a web page may also be modeled in an alternate representation as a sequence of leaf nodes from which the word sequence is derived. Each node has an associated XPath expression (also referred to as XPath) that indicates the location of the node in the web page. Each node also has, or can be assigned, a unique identifier (ID) equal to the (text, XPath) value pair for the node—this ID is unique within the detail web page containing the node.

In most pages, the text contained in a node is part of a single attribute value; thus, all words of a node would have the same attribute label. The label for node n is denoted herein by lbl(n). Furthermore, an attribute value may not be restricted to a single node, but rather may span multiple (consecutive) nodes. For example, an address attribute can be formatted differently across web sites—as one monolithic node that includes street name, city, zip, etc., or in a different format in which street name, city, zip, etc., are split across different nodes. If there are multiple nodes with identical IDs, then uniqueness may be ensured by numbering the multiple nodes and including the assigned number as part of the corresponding ID.

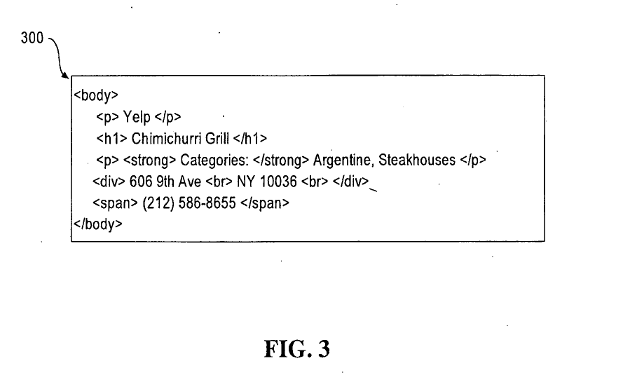

For example, FIG. 3 is block diagram that illustrates a simplified HTML code fragment 300 for a portion of the web page depicted in FIG. 1A. According to the processing model described herein, the nodes in HTML code fragment 300 with text, XPaths, and labels are shown in Table 1 below.

TABLE 1
Nodes and node information for code fragment in FIG. 3

| Node | Text | XPath | Label |
|---|---|---|---|
| n₁ | Yelp | /body/p | Noise |
| n₂ | Chimichurri Grill | /body/h1 | Name |
| n₃ | Categories: | /body/p/strong | Noise |
| n₄ | Argentine, Steakhouses | /body/p | Category |
| n₅ | 606 9^{th} Ave | /body/div | Address |
| n₆ | NY 10036 | /body/div | Address |
| n₇ | (212) 586-8655 | /body/span | Phone |

As indicated in Table 1, according to the processing model node n₁ has an ID of (“Yelp”, /body/p), node n₃ has an ID of (“Categories:”, /body/p/strong), and node n₅ has an ID of (“606 9^{th} Ave”, /body/div). Further, according to the processing model the HTML code fragment 300 in FIG. 3 includes the following word sequence:
“Yelp Chimichurri Grill Categories: Argentine, Steakhouses 606 9^{th} Ave NY 10036 (212) 586-8655”

In one embodiment, the input to a web extraction system is a small subset of web sites Wₜ [symbol] W which serves as the training data for deriving the classification model used by the extraction mechanism. Each node of a web page belonging to a web site in Wₜ has an associated attribute label. The node labels are obtained by having human users annotate attribute values in a small sample of web pages from each site in Wₜ. From these annotated web pages for a web site, wrappers are learned and thereafter used to assign attribute labels to the remaining web pages belonging to the site. These labeled page sequences belonging to sites in Wₜ serve as the input training data for the extraction system. The nodes in the page sequences for web sites in W-Wₜ (i.e., for web sites in W that do not belong to Wₜ) are unlabeled—that is, they do not have associated attribute labels.

The goal achieved by the techniques described herein is to assign attribute labels A₀, . . . , Aₘ to nodes of page sequences belonging to sites in W-Wₜ. Specifically, for a new, unlabeled web site Ŵ ε W-Wₜ (i.e., web site Ŵ in W that does not belong to Wₜ), the techniques described herein use the labeled web pages from Wₜ to assign attribute labels to page sequence nodes of web site Ŵ without any further human intervention.

### Example Mechanism for High-Precision Web Extraction

### Overview

The techniques for high-precision web extraction described herein have two phases: a training phase and a labeling phase. The training phase uses training data from web sites in Wₜ to train a linear-chain CRF model, while the labeling phase assigns attribute labels to unlabeled web pages of a web site Ŵ that belongs to the same vertical as the web sites in Wₜ.

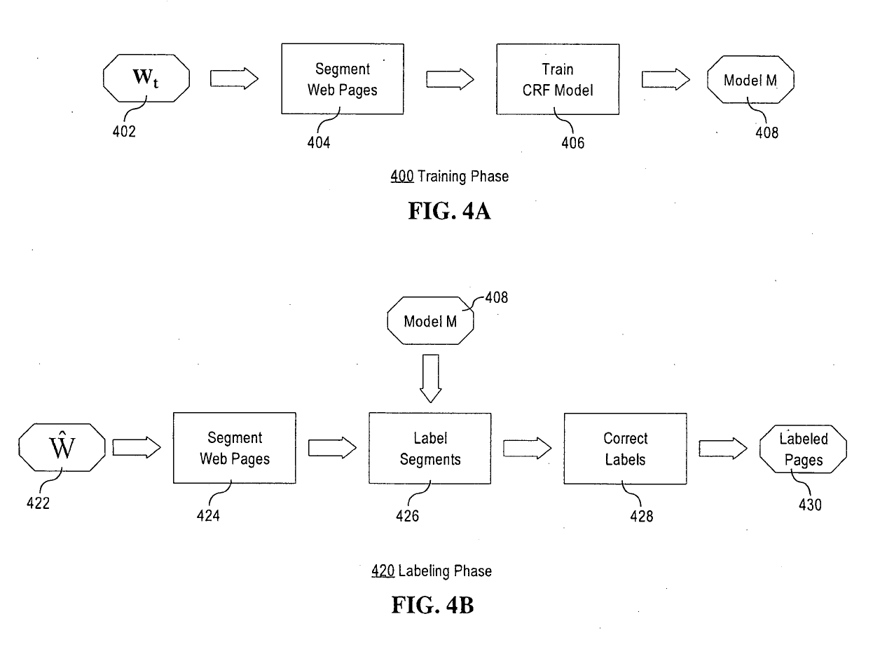

FIG. 4A is a block diagram that illustrates a training phase 400 according to one embodiment. A small subset of web pages 402 from web sites Wₜ is used to derive training data. For example, web pages 402 are annotated or tagged by a human user to label or otherwise indicate the page attributes of interest. Thereafter, a wrapper is automatically learned from web pages 402, and the wrapper is then used to annotate the remaining web pages belonging to the web sites Wₜ. In step 404, the annotated web pages from web sites Wₜ are partitioned into a set of segments in accordance with the techniques described herein. In step 406, a CRF model is trained based on the set of segments, and as a result the parameters of a CRF model 408 are determined.

FIG. 4B is a block diagram that illustrates a labeling phase 420 according to one embodiment. Unlabeled web pages 422 are extracted or otherwise obtained from web site Ŵ that belongs to the same vertical as web sites Wₜ. In step 424, the unlabeled web pages 422 are partitioned into a set of segments in accordance with the techniques described herein. In step 426, the attributes in unlabeled web pages 422 are assigned labels by applying CRF model 408 to the derived set of segments. In step 428, one or more labels that were erroneously assigned to one or more attributes in the set of segments are identified, the correct labels for the one or more attributes are determined, and the erroneously assigned labels are fixed by assigning the correct labels to the one or more attributes. The result from step 428 is a set of labeled web pages 430. Thereafter, the labeled attributes are extracted from the set of web pages 430 based on the assigned and corrected labels.

According to the techniques described herein, a pre-processing step is performed in both training phase 400 and labeling phase 420, where the pre-processing step includes partitioning input page sequences into short segments. In the training phase 400, the labeled page segments are used to train a CRF model. This model is then employed in the labeling phase 420 to assign attribute labels to individual attributes in page segments derived from unlabeled web pages in web site Ŵ. Since many of the labels assigned by applying the CRF model are likely to be incorrect, a post-processing step in the labeling phase 420 is performed to correct all or at least most of the erroneously assigned labels.

### Segmenting Web Pages

According to the techniques described herein, the step of segmenting web pages is performed in a similar manner in both the training phase and the labeling phase, except that the training phase uses labeled web pages and the labeling phase uses unlabeled web pages.

Web pages belonging to a site typically contain a fair amount of text that repeats across the pages of the site. Such static text is identified and is used to segment web pages belonging to a given web site W by performing the following two steps.

1. Identifying static nodes. A node n in a web page p (in W) is considered static if a significant fraction α of web pages in W contain nodes with the same ID (e.g., the same (text, XPath) value pair) as n. The static nodes can be detected by storing all the nodes in a hash table indexed by their IDs. Let N be a set of nodes with the same ID in a hash bucket. The nodes in N are marked as static if these nodes occur in at least α fraction of web pages in W. In one embodiment, a value of 0.8 has been empirically determined to be a good setting for α.

2. Segmenting pages. A web page p in W may be partitioned into segments using static nodes as follows. Each node sequence between any two consecutive static nodes is treated as a separate segment. More formally, let nⱼ, nⱼ₊₁, . . . , n_{q} be a subsequence of web page p such that nⱼ and n_{q} are static nodes, and nⱼ₊₁, . . . , n_{q-1} are not. Then, nⱼ₊₁, . . . , n_{q-1} is a segment with ID equal to the ID of node nⱼ. Thus, each segment s has an ID that is equal to the ID of the stating node preceding s in the web page p.

It is noted that there may be multiple segments with the same ID across the web pages of a web site. However, there is at most one segment with a fixed ID e per page. Furthermore, attributes that satisfy the uniqueness constraint (e.g., restaurant name, address) lie entirely within a single segment although they may span one or more consecutive nodes within the segment. On the other hand, attributes with multiple occurrences like user reviews (or noise) may span multiple segments. Finally, due to page structure similarity, each attribute occurs in segments with the same ID(s) across the web pages.

For example, in the web page illustrated in FIG. 3 and described in Table 1, nodes n₁ and n₃ with text “Yelp” and “Categories:”, respectively, are static nodes that repeat across the www.yelp.com web site. These nodes partition the web page into two segments:

s₁=n₂ with ID (“Yelp”, /body/p),

s₂=n₄·n₅·n₆·n₇ with ID (“Categories:”, /body/p/strong).

Further, the word sequences in s₁ and s₂ are “Chimichurri Grill” and “Argentine, Steakhouses 606 9th Ave NY 10036 (212) 586-8655”, respectively.

Training CRFs models and labeling using segments leads to higher accuracy compared to full page sequences. This is because segmentation filters out static nodes that are basically noise. Further, it ensures that attribute occurrence patterns of the training web sites is not reflected in the CRF model. This leads to more accurate labeling because the structure of a new, unlabeled web site Ŵ can be very different from the structure of the web pages in the training set. Finally, labeling over segments ensures that errors in assigning labels in one segment do not propagate to other segments.

It is noted that in addition to static nodes, the techniques described herein can also use static repeating text like “Price:”, “Address:”, “Phone:”, etc. that occurs at the start of nodes with identical IDs to segment pages. The static text identification mechanism described in this section is different than other text identification mechanisms. For example, the primary goal in other text identification mechanisms is to detect static text at the coarsest-possible granularity (e.g., navigation subpages) so that such static text can be eliminated from further processing like indexing. In contrast, the static text identification mechanism described herein detects fine-grained static content such as, for example, “Categories:” for the purpose of segmenting pages.

### Training Classification Models

According to the techniques described herein, a classification model is determined during the training phase.

In one embodiment, the techniques described herein are implemented based on a CRF model. It is noted, however, that the techniques described herein are not limited to using a CRF model. Rather, the techniques described herein may be implemented in conjunction with any existing machine learning techniques and classification models such as, for example, Support Vector Machine (SVM) models.

In one CRF-based embodiment, the techniques described herein employ a linear-chain CRF model to label attribute occurrences in web pages. A linear-chain CRF model represents the conditional probability distribution P(l|w), where w: <w₁w₂ . . . w_{T}> is a sequence of words and l: <l₁l₂ . . . l_{T}> is the corresponding label sequence. The conditional probability distribution is given by

$$P ( l \vert w ) = \frac{1}{Z ( w )} exp ( {\sum }_{t = 1}^{T} {\sum }_{k = 1}^{K} {λ}_{k} {f}_{k} ( {l}_{t - 1} , {l}_{t ,} w , t ) )$$

where ƒ₁, ƒ₂, . . . , ƒₖ are feature functions, λₖ is the weight parameter for feature function ƒₖ, and Z(w) is the normalization factor. During training, the parameters λₖ of the CRF model are set to maximize the conditional likelihood of the training set {(wⁱ, lⁱ)}. Then, for an input sequence w, inference of the label sequence l with the highest probability is carried out using the Viterbi algorithm.

### Assigning Labels to Attributes

According to the techniques described herein, during the training phase labels are assigned to attributes that occur in the unlabeled web pages of a given web site Ŵ. Table 2 below lists pseudo code that can be used to implement label assignment according to one embodiment.

TABLE 2
Pseudo code for labeling attributes in Web pages of web site Ŵ

```
Pseudo Code: Label_Pages (Ŵ, M)
Input: Web site to be labeled Ŵ, CRF model M;
Output: Labeled page sequences from Ŵ;
Segment page sequences in web site Ŵ using static nodes;
Let S denote the set of page segments;
Label static nodes in pages of Ŵ as Noise;
Use CRF model M to assign attribute labels to words in each segment in
S;
for each segment node n do
  Set label to majority label for words in n;
end for
S′ = Select_Segment(S);
for each segment ID e do
  Let Sₑ denote the segments with ID e in S′;
  S′ₑ = Correct_Labels(Sₑ);
  for each segment sε S′ₑ do
    Let p be the page in Ŵ that contains s;
    for each node nε s do
      Set the label for node n in p equal to the label for node n in s;
    end for
  end for
end for
return Ŵ;
```

The pseudo code in Table 2 starts with segmenting the web pages in web site Ŵ and labeling words in the individual segments using the trained CRF model M. (It is noted that in one experimental embodiment good results were obtained even by labeling words in the individual nodes.) Since all words within a segment node belong to the same attribute, the majority label is chosen as the label for that node. This helps to fix some of the wrong word labels at a node level. At this point, although a majority of the nodes will be labeled correctly by applying CRF model M, there may still be a sizeable number of nodes with incorrect labels. For example, for certain multi-value attributes like Address the error rates may be as high as 75%. The techniques described herein exploit attribute uniqueness constraints, proximity relationships among attributes, and the structural similarity of pages to correct erroneous labels. For the purposes of illustration, the pseudo code described herein assumes that all non-noise attributes have a uniqueness constraint. A mechanism for handling attributes with multiple occurrences that span segments is discussed in a separate section hereinafter.

Within a web page, attribute values are contiguous, and thus do not span segments. As a result, each attribute occurs within a single segment. Further, since pages in web site Ŵ have similar structure, each attribute occurs in segments with the same ID across the pages. In the pseudo code in Table 2, Procedure Select_Segment( ) identifies the single segment ID for each attribute, and converts the occurrences of the attribute label outside the segment ID to noise. Within segments with a specific ID identified for each attribute, there may still be errors involving the attribute label. These are corrected by Procedure Correct_Labels( ) using a scheme based on edit distance, which exploits page structure similarity while allowing for minor structural variations. Pseudo code and descriptions for Procedures Select_Segment( ) and Correct_Labels( ) are described in the sections that follow.

### Selecting Segments for Attributes

Table 3 below lists pseudo code that can be used to implement Procedure Select_Segment( ) according to one embodiment.

TABLE 3
Pseudo code for Procedure Select_Segment( )

```
Pseudo Code: Select_Segment (S)
Input: Set of segments S;
Output: Set of segments S with a single segment ID selected for each
attribute;
for each segment ID e do
  attr(e) = {A : A occurs in more than β·sup(e) segments with ID e in S};
end for
for each segment ID e do
  wₑ = Σ_{f}dist(e, f)·|attr(f)|;
end for
for each non-noise attribute A do
  seg(A) = segment ID e with minimum weight wₑ whose attr set contains
  A;
  for each segment s in S with ID e ≠ seg(A) do
    Set attribute labels for all nodes in s with label A to Noise;
  end for
end for
return S;
```

Procedure Select_Segment( ) selects a single segment ID for each non-noise attribute A, and stores it in seg(A). The procedure starts by computing for every segment ID e, the attributes for which e is a candidate, and stores these attributes in attr(e). Here, the fact that a majority of the labels assigned by CRF model M will be correct is exploited. Thus, for e to be a candidate for an attribute A, A must occur frequently enough in segments with ID e. For a segment ID e, sup(e) denotes the number of segments with ID e in S. Then, attribute A is included in attr(e) if A occurs in more than β·sup(e) segments with ID e, where β≈0.5.

If attribute A occurs in the attr set of only one segment with ID e, then the segment ID seg(A) containing attribute A is unique and is equal to e. However, if A occurs in the attr set of segments with more than one segment ID, then there may be multiple candidate segment IDs for A. Thus, one of the candidate segment IDs needs to be selected. In order to select the segment ID seg(A) for attribute A, it is observed that attributes typically appear in close proximity to each other in web pages. For a pair of segment IDs e and ƒ, let dist(e, ƒ) denote the average distance between segment pairs with IDs e and ƒ over all web pages being processed. The distance between a pair of segments is defined as the number of intermediate segments between the pair. Alternatively, the distance between a pair of segments may be defined to be the number of hops between the start nodes of the segments in the DOM tree of the page.

The goal then is to select a single segment ID seg(A) for each attribute A such that A ε attr(seg(A)) and Σ_{AA′}dist(seg(A), seg(A′)) is minimum. The first condition ensures that seg(A) is a candidate for attribute A while the second condition ensures that the segment IDs for attributes appear close to each other. It is noted that selecting segment IDs for attributes so that the total distance between all segment ID pairs is minimized is an NP-hard problem.

To reduce the complexity of such selection, in one embodiment the techniques described herein use a heuristic to select segment IDs for attributes. In this embodiment, the heuristic assigns a weight wₑ to each segment ID e based on the distance of this segment ID to other segment IDs that are candidates for attributes. Segment IDs that have larger attr sets are more likely to be chosen as the segment ID for an attribute. Thus, when computing wₑ for a segment ID e, the distance to each segment ID is weighed by the number of attributes that this segment ID is a candidate for. Then, the seg(A) whose weight is the minimum is selected to be the segment ID for attribute A. The observation here is that when there are multiple competing segments that contain an attribute label, a preference should be given to the segment that is closest to other segments that contain attribute labels.

Finally, for each attribute A, once seg(A) is assigned, all labels assigned to attribute A in segments with ID not equal to seg(A) are re-labeled as noise. Thus, at the end of this step, only segments with ID seg(A) contain nodes labeled as attribute A.

### Correcting Attribute Labels in Segments

After the segment IDs for each attribute have been selected, while the majority of segment nodes would be labeled correctly, some node labels may still be incorrect. For this reason, the techniques described herein provide for correcting the labels for each attribute A in segments with ID seg(A). Since web pages within a given web site are script-generated, the web pages would have similar (but not necessary identical) structure. For instance, there may be small variations in the structure of different web pages due to missing attributes.

One solution for correcting labels would be to number nodes from the start in each segment. Then, the attribute label for all nodes in position i (of segments with identical IDs) can simply be changed to the majority label in that position. The disadvantage of this solution is that due to missing attributes, nodes in the same position i across the segments may contain values belonging to multiple different attributes. Hence, assigning the majority label to these values can cause nodes to be incorrectly labeled. Similarly, grouping nodes with identical XPaths and assigning the majority label to all nodes in a group may not work either. This is because different attributes may have identical XPaths, e.g., if the different attributes are elements of a list.

To address the disadvantages of these label-correction solutions, the techniques described herein rely on the observation that that even though attributes may appear at variable node positions within a segment, since web pages share a common template, the variations across segments with the same ID will be minor, and primarily due to: (1) missing or additional nodes in certain segments, and (2) incorrectly labeled nodes in some segments. Thus, the edit distance between segments (restricted to node labels and XPaths) with the same segment ID will generally be small, where the edit distance is defined as a sequence of operations which, if applied to a segment, would match the structure of that segment to another segment. The techniques described herein use the edit distance to provide a more accurate solution for correcting the label assignments to nodes of segments in Sₑ with segment ID e.

Table 4 below lists pseudo code that can be used to implement Procedure Correct_Labels( ) for correcting erroneously assigned labels according to one embodiment.

TABLE 4
Pseudo code for Procedure Correct_Labels( )

```
Pseudo Code: Correct_Labels (Sₑ)
Input: Set of segments Sₑ with segment ID e;
Output: Set of segments Sₑ with corrected labels;
for each segment sε Sₑ do
  S′ = { min_op_seq (s, s′) : s′ε Sₑ };
  for each node n in segment s do
    count(lbl(n)) = |{os : osε S′ [symbol]  os does not contain del or rep
    operation involving n}|;
    for each attribute label l ≠ lbl(n) do
      count(l) = |{os : osε S′ [symbol]  os contains edit operation
      rep(n, lbl(n), l) }|;
    end for
    Set lbl(n) = arg maxₗ count(l);
    Set sup(n) = maxₗ count(l);
  end for
  for each non-noise attribute A that appears in s do
    Select node n in s with maximum support sup(n) from among nodes
    with label A;
    for each node n′ ≠ n in s with label A do
      if n and n′ are separated by a node with label different from A then
        Set label for n′ to be equal to Noise;
      end if
    end for
  end for
end for
return Sₑ;
```

Let segment s=n₁ . . . nᵤ with assigned attribute labels l₁, . . . , lᵤ and XPaths x₁, . . . , xᵤ for the nodes n₁ . . . nᵤ. The labels in s are adjusted by computing a minimal sequence of edit operations (on nodes of s) which, if applied, would ensure that s matches every other segment s′ ε Sₑ. Then, the label for each node is selected based on the majority operation. The edit operations on s used by the techniques described herein are: (1) del(nᵢ)—delete node nᵢ from s; (2) ins(n′ᵢ, l′ᵢ, x′ᵢ)—insert a new node n′ᵢ with label l′ᵢ and XPath x′ᵢ into s; and (3) rep(nᵢ, lᵢ, l′ᵢ)—replace the label lᵢ of node nᵢ in s with label l′ᵢ. Segments s and s′ are considered to match if their label and XPath sequences match. The ins( ) and del( ) operations align corresponding node pairs in s and s′—these node pairs essentially have identical XPaths and belong to the same attribute. On the other hand, the rep( ) operation detects label conflicts between the corresponding node pairs.

For a segment s, let S′ denote the set of minimum edit operation sequences for s to match every s′ ε Sₑ (with one operation sequence in S′ for each s′). Then, for a node nᵢ in s, if the majority operation in S′ is rep(nᵢ, lᵢ, l′ᵢ), then this means that a majority of the nodes corresponding to nᵢ in the other segments in Sₑ have label lᵢ. Since most of these node labels are correct, the label of node nᵢ needs to be changed from lᵢ to l′ᵢ. Similarly, if a majority of sequences in S′ contain no operation involving nᵢ, then this implies that the labels of most other corresponding nodes agree with nᵢ's label lᵢ, and so label lᵢ must be correct and should be left as is. It is noted that operation del(nᵢ) basically means that the corresponding node for nᵢ is absent from s′, and hence the attribute for nᵢ is missing from s′. Furthermore, there cannot be an ins( ) operation in S′ involving a node nᵢ in s. So, del( ) and ins( ) operations can be safely ignored when computing the majority operation for a node nᵢ.

Minimal Edit Operations. Let s=n₁ . . . nᵤ (with labels l₁, . . . , lᵤ and XPaths x₁, . . . , xᵤ) and s′=n′₁ . . . n′ᵥ (with labels l′₁, . . . , l′ᵥ and XPaths x′₁, . . . , x′ᵥ) be segments in Sₑ. Segments s and s′ are said to match if u=v, and for all 1≦i≦u, lᵢ=l′ᵢ and xᵢ=x′ᵢ. Suppose that s=n₁·t and s′=n′₁·t′. Then, the minimum number of edit operations min_op_num(s, s′) required so that s matches s′ can be computed recursively, and is the minimum of the following three quantities:

(1) min_op_num(t, t′)+c(n₁, n′₁), where c(n₁, n′₁) is equal to:
0 if l₁=l′₁ and x₁=x′₁,
1 if l₁≠l′₁ and x₁=x′₁, and
∞ if x₁≠x′₁.

(2) min_op_num(s, t′)+1.

(3) min_op_num(t, s′)+1.

The above quantity (1) tries to match n₁ with n′₁ and t with t′. If l₁ and l′₁ are already equal and so are x₁=x′₁, then no operations are needed to match n₁ and n′₁. However, if l₁≠l′₁, then a single operation is needed to replace l₁ with l′₁. If x₁≠x′₁, then n₁ cannot be matched with n′₁. This is because n₁ and n′₁ cannot belong to the same attribute if their XPaths are different. Quantity (2) corresponds to inserting n₁ with label l₁ and XPath x₁ into s. Quantity (3) corresponds to deleting n₁ from s.

Thus, the minimum sequence of edit operations min_op_seq (s, s′) needed to match s with s′ can also be computed recursively (in parallel with min_op_num (s, s′)), and essentially depends on which of the above three quantities leads to the minimum value for min_op_num (s, s′). If quantity (1) has the minimum value, then min_op_seq (s, s′) is equal to o·min_op_seq (t, t′) where operation o is null if l₁=l′₁ and x₁=x′₁, and o=rep(n₁, l₁, l′₁) if l₁≠l′₁ and x₁=x′₁. If quantity (2) has the minimum value, then min_op_seq (s, s′) ins(n′₁, l′₁, x′₁)·min_op_seq (s, t′). Else, if quantity (3) has the minimum value, then min_op_seq (s, s′)=del(n₁)·min_op_seq (t, s′).

Description of Procedure Correct_Labels( ). For each segment s with segment ID e, Correct_Labels( ) first computes the minimum sequence of edit operations between s and every other segment s′ ε Sₑ, and stores these in S′. For each node n (with current label lbl(n)) in s, Correct_Labels( ) computes the new label based on the majority operation as follows. It first calculates count(lbl(n)), which is the number of operation sequences in S′ that contain zero del( ) or rep( ) edit operations involving node n. This is essentially the number of operation sequences in which the label of node n is left unchanged. For a label l≠lbl(n), count(l) stores the number of operation sequences in which the label of node n is replaced with label l. Then, the new label for node n in s is set to that attribute label l for which count(l) is maximum. Any ties may be broken in favor of lbl(n) whenever possible, and arbitrarily otherwise. The support sup(n) of node n is set to be equal to this maximum value of count(l). Finally, for each attribute A whose label appears in segment s, the sequence containing the node n with maximum support sup(n) is selected from among the maximum contiguous sequences of nodes with label A. The labels of nodes with label A that lie outside this sequence are re-labeled as noise. (In some embodiments, another option would be to output the maximum contiguous sequence of nodes that are all labeled A and whose average support is maximum.)

Operational Example of Correcting Labels. An operational example is described with respect to the web page portion depicted in FIG. 3. In this example, three segments s₁, s₂, and s₃ with the same segment ID of (“Categories:”, /body/p/strong) from three different web pages have been identified and labeled in accordance with the techniques described herein. (For illustration purposes, this example assumes that the Phone attribute is missing from all three segments.) The node texts, Xpaths, and labels for the three segments are as follows:
s₁=n₁₁·n₁₂·n₁₃, and has node text “Argentine, Steakhouses”, “606 9th Ave”, and “NY 10036”; s₁ has node labels “Category”, Noise, and Noise, respectively; and s₁ has node XPaths “/body/p”, “/body/div”, and “/body/div”, respectively. It is noted that in segment s₁ the Category attribute is labeled correctly, but the Address attribute has been wrongly labeled as Noise.
s₂=n₂₁·n₂₂, and has node text “21 West 52^{nd} St”, and “NY 10019”; s₂ has node labels “Address” and “Address”; and s₂ has node XPaths “/body/div” and “/body/div”. It is noted that in segment s₂ the Category attribute is missing, but the Address attribute is labeled correctly.
s₃=n₃₁·n₃₂·n₃₃, and has node text “American”, “10 Columbus Circle”, and “NY 10019”; s₃ has node labels “Category”, “Address”, and “Address”, respectively; and s₃ has node XPaths “/body/p”, “/body/div”, and “/body/div”, respectively. It is noted that in segment s₃ all attributes are labeled correctly.

According to the techniques described herein, correcting the assigned labels in segment s₁ produces the following results:

min_op_seq (s₁, s₁)=ε, which the empty sequence;

min_op_seq (s₁, s₂)=del(n₁₁)·rep(n₁₂, Noise, Address)·rep(n₁₃, Noise, Address);

min_op_seq (s₁, s₃)=rep(n₁₂, Noise, Address)·rep(n₁₃, Noise, Address).

Thus, since for node n₁₁ the count(Category)=2, the label for node nil stays as “Category”. The labels for nodes n₁₂ and n₁₃ are modified to “Address” since count(Address)=2 for these nodes.

### Attributes with Multiple Occurrences Spanning Segments

In some operational scenarios, attributes with multiple occurrences may span multiple segments. Thus, the uniqueness constraint does not hold for such attributes. For example, in web sites from a restaurant vertical, certain attributes like user reviews may have multiple disjoint occurrences that are spread over multiple segments in a web page. For such attributes A, seg(A) may not be a single segment ID but may be a set of segment IDs that occur in close proximity.

The techniques described herein may handle such scenario in Procedure Select_Segment( ) by clustering the candidate segment IDs for attribute A into multiple clusters (that is, by clustering segment IDs whose attr set contains A) based on the distance of the candidate segments from one another. Then, a cluster is selected from the multiple clusters, where the selected cluster has a segment ID whose average weight (e.g., sum of weights wₑ of segment IDs e divided by the number of segment IDs in the cluster) is minimum. Thus, seg(A) would contain all the segment IDs in the selected cluster, and all occurrences of A in segments with segment IDs not in seg(A) would be converted to noise. The segments with segment IDs in seg(A) may then be processed using the Correct_Labels( ) procedure to correct any erroneously assigned labels.

### Experimental Evaluation of Example Embodiment

In an experimental study, an example embodiment of the techniques for high precision web extraction described herein has been compared to a baseline CRF-based extraction scheme on real-life restaurant web pages.

Dataset. The experimental study used restaurant web pages from the following 5 real-world web sites: www.citysearch.com, www.frommers.com, www.nymag.com, www.superpages.com, and www.yelp.com. The dataset included a total of 455 web pages. The number of web pages from each of the above 5 sites was 92, 71, 95, 100, and 97, respectively. In each web page, attribute labels were assigned to the following 5 attributes: Name (N), Address (A), Phone number (P), Hours of operation (H), and Description (D). The attribute labels were obtained by first manually annotating a few sample pages from each site, and then using wrappers to label the remaining web pages in each site. All words that did not belong to any of the 5 above-mentioned attributes were labeled as noise. The order of attributes in the 5 web sites was found to be: NAPHD, NHAPD, NAPDH, NPAH, and NAPH. Thus, there was considerable variation in the attribute ordering across the 5 web sites, and presumably this made traditional CRF-based approaches less suitable for extraction. The experimental study used 50 web pages from one web site as test data, and all the pages from the remaining 4 sites as training data.

Extraction Methods. The experimental study compared the performance of the techniques described herein with the performance of a baseline CRF-based extraction scheme. To measure the incremental improvement in accuracy that was obtained from each of the extraction steps of the techniques described herein, the experimental study also considered successive extraction schemes that were derived by adding pre- and post-processing steps to the baseline scheme.

Baseline (CRF). This was the baseline extraction scheme against which comparisons were made. The experimental study used a linear-chain CRF model that was built on the word sequence formed from all the leaf nodes in the DOM tree of the complete web pages.

Node CRF (NODE). In this extraction scheme, the experimental study trained the linear-chain CRF model on word sequences for individual nodes in page segments rather than the word sequence for the entire page. (Although training on word sequences for individual segments was possible, it was found that training at a node granularity resulted in better performance.) All nodes belonging to non-noise attributes were included in the training set. In addition, a fraction of nodes was randomly labeled as noise. It was found that including all the noise nodes during training results in the CRF model being able to label most of the nodes in the test web pages as noise. In the experiments described below, the fraction of noise nodes used for training was 10%. Static nodes were not included as part of the training or test data.

Node CRF+Segment Selection (SS). In addition to training on word sequences for nodes, this extraction scheme used proximity constraints to identify the correct segment for each attribute.

Node CRF+Segment Selection+Edit Distance (ED). This was the extraction scheme which implemented the complete techniques described herein including the pre-processing and the post-processing steps. This scheme also performed the final step in which edit distance was used to correct the labels on wrongly labeled nodes.

CRF Features. In the experimental study, the CRF models only used features based on the content of HTML elements in the web pages. Structure or presentation information like font, color, etc. was not used as CRF features since these are not robust across web sites. The binary features used in the experimental study fell into the following three categories.

Lexicon Features. Each word from the training set constituted a feature. A lexicon was built over the words appearing in the training web pages. If a word in a web page was present in the lexicon, then the corresponding feature was set to 1.

Regex Features. Occurrences of certain patterns in the content was captured by regex features. Some examples of regex features are: “isAllCapsWord” (which fires if all letters in a word are capitalized); “3digitNumber” (which indicates the presence of at least one 3-digit number); and “dashBetweenDigits” (which indicates the presence of a ‘-’ in between numbers). The total number of regex features used in the experimental study was 11.

Node-level Features. These features captured length information for a node, and overlap of the node text with the page title. Some examples include “propOfTitleCase”, which indicates what fraction of the node text contains words that begin with a capital letter, and “overlapWithTitle” which indicates the extent of overlap of given text with the <title>tag of the web page containing that text. The fractional features were converted to binary features by comparison to a threshold. The total number of node-level features used in the experimental study was 7.

The node-level features described above were the same for all the words in a node. Various combinations of the regularization parameter σ and normalization type (L1 or L2) were tried. The best performance was obtained with L1 normalization and σ=5. The CRF implementation used in the experimental study was the CRFsuite, which can be found at “http://www.chokkan.org/software/crfsuite/”.

Evaluation Metrics. The experimental study used the standard precision, recall, and F1 measures to evaluate the extraction schemes. For each scheme, the above measures were averaged across 5 experiments—each experiment treated a single web site as the test site, and uses the web pages from the remaining 4 web sites as training data.

Experimental Results. The results of the experimental study are summarized in Table 5 below. Table 5 lists the precision, recall, and F1 numbers for the various schemes. As indicated in Table 5, the baseline CRF scheme had the worst performance. The reason for this is that the orders of the attribute are different across the web sites, and thus the training web pages contained lots of noise which biased the baseline CRF model to label most nodes as noise.

TABLE 5
Comparison of extraction schemes

| | Label | CRF | NODE | SS | ED |
|---|---|---|---|---|---|
| Precision | Name | 0.39 | 0.78 | 1 | 1 |
| | Phone | 0.02 | 0.59 | 1 | 1 |
| | Address | 0.01 | 0.24 | 0.8 | 0.81 |
| | Hours | 0.22 | 0.67 | 1 | 1 |
| | Desc | 0.13 | 0.22 | 0.25 | 0.25 |
| | Overall | 0.15 | 0.5 | 0.81 | 0.81 |
| Recall | Name | 0.34 | 0.98 | 0.98 | 1 |
| | Phone | 0.2 | 0.99 | 0.98 | 0.99 |
| | Address | 0.16 | 0.88 | 0.82 | 0.83 |
| | Hours | 0.36 | 0.89 | 0.89 | 1 |
| | Desc | 0 | 0.4 | 0.15 | 0.15 |
| | Overall | 0.21 | 0.83 | 0.76 | 0.79 |
| F1 | Name | 0.36 | 0.85 | 0.99 | 1 |
| | Phone | 0.04 | 0.69 | 0.99 | 0.99 |
| | Address | 0.02 | 0.33 | 0.8 | 0.81 |
| | Hours | 0.26 | 0.74 | 0.94 | 1 |
| | Desc | 0.01 | 0.26 | 0.19 | 0.19 |
| | Overall | 0.14 | 0.57 | 0.78 | 0.8 |

Result Analysis. The performance of each extraction scheme that included steps in accordance with the techniques described herein is described below.

NODE. As can be seen from Table 5, the NODE scheme outperformed the baseline CRF scheme—this is because of shorter sequences and less noise in the training data. Furthermore, training at the granularity of a node ensured that the CRF model does not learn the inter-attribute dependencies in the training data that do not hold in the test data. It is noted that the recall of NODE is high for most of the attributes but the precision is moderate to low across attributes. This is because the experimental study used only content features, and node labeling was done without taking into account constraints like attribute uniqueness. For example, many restaurant pages contain multiple instances of addresses of which only one is the restaurant address. The NODE scheme labeled all instances as addresses leading to reduced precision. Also, it is noted that the precision is higher for single-node attributes like Name, Phone, and Hours compared to multi-node attributes like Address and Description because in the former case the training is on entire attributes as opposed to parts of attributes in the latter case.

SS. Performing segment selection in the SS scheme boosted the precision of all attributes. (On an average, each page was split into 40 segments.) The minimum and maximum increase in precision were 28% (for Name) and 150% (for Address). This demonstrates the effectiveness of uniqueness and proximity constraints to resolve multiple occurrences of an attribute in a page. It is noted that for constraint satisfaction to be effective the recall of the underlying CRF needs to be high since high recall ensures that the correct segment is selected. This also explains why SS performs poorly on Description since the recall of the CRF on Description is low (40%) and this leads to the wrong segment being selected.

ED. The ED scheme had the best overall performance. It improved the recall of Hours by 11% by fixing incorrectly labeled Hour nodes.

### Hardware Overview

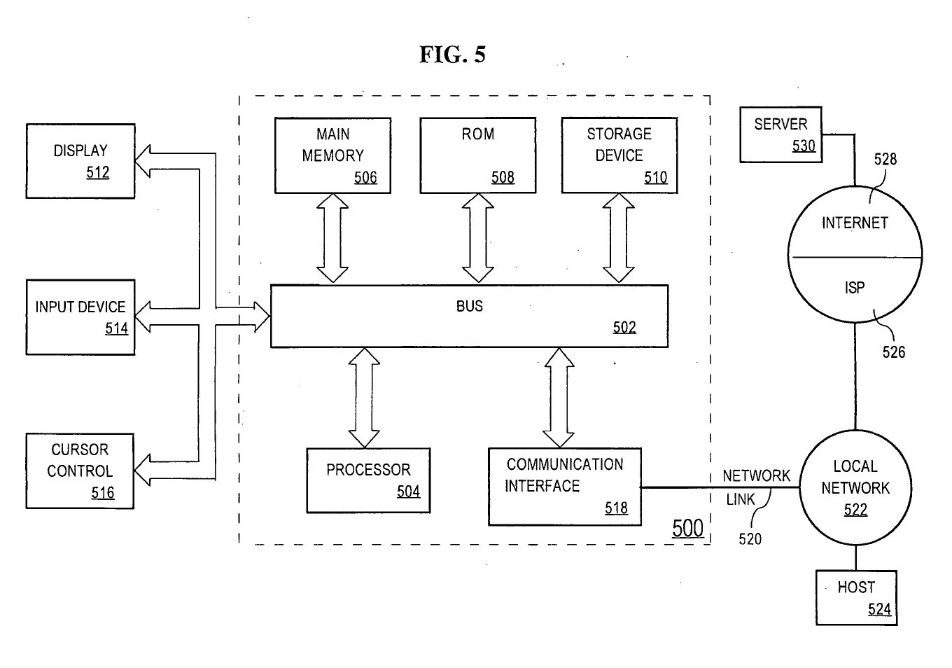

The techniques described herein for high precision web extraction may be implemented in various operational contexts and on various kinds of computer systems that are programmed to be special purpose machines pursuant to instructions from program software. For purposes of explanation, FIG. 5 is a block diagram that illustrates an example computer system 500 upon which embodiments of the techniques described herein may be implemented.

Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein for high precision web extraction. According to one embodiment, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operate in a specific fashion. In an embodiment implemented using computer system 500, various computer-readable media are involved, for example, in providing instructions to processor 504 for execution. Such a medium may take many forms, including but not limited to storage media and transmission media. Storage media includes both non-volatile media and volatile media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine such as, for example, a computer system.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
identifying portions of repeating text in unlabeled web pages from a particular web site;
based on the portions of repeating text, partitioning the unlabeled web pages into a set of segments;
assigning, to multiple attributes in the set of segments, multiple labels that respectively correspond to the multiple attributes, wherein assigning the multiple labels comprises applying a classification model to each separate segment in the set of segments;
identifying first one or more labels that were erroneously assigned to one or more attributes in the set of segments;
determining second one or more labels that are correct for the one or more attributes in the set of segments; and
correcting the first one or more labels in the set of segments by assigning the second one or more labels to the one or more attributes.

2. The method of claim 1, further comprising determining the classification model based on a set of annotated web pages from one or more web sites that are different than the particular web site.

3. The method of claim 2, wherein determining the classification model comprises:
identifying one or more static nodes in the set of annotated web pages;
based on the one or more static nodes, partitioning the set of annotated web pages into multiple training segments; and
deriving the classification model based on the multiple training segments, wherein the classification model comprises a set of parameter values which can be used to determine and label different attributes in page segments that are not annotated.

4. The method of claim 2, wherein determining the classification model comprises determining the set of annotated web pages, wherein determining the set of annotated web pages comprises:
receiving user input that indicates one or more annotations that are associated with, and label, one or more nodes for a particular web page of the set of annotated web pages; and
using the one or more annotations to label the remaining web pages in the set of annotated web pages.

5. The method of claim 1, wherein partitioning the unlabeled web pages comprises:
from the unlabeled web pages, determining static nodes that correspond to the portions of repeating text;
assigning, to the static nodes, unique identifiers that respectively identify the static nodes, wherein each unique identifier comprises the content of a corresponding node and an XPath expression that identifies the location of the corresponding node in at least one of the unlabeled web pages; and
partitioning each of the unlabeled web pages based on the unique identifiers.

6. The method of claim 1, wherein assigning the multiple labels to the multiple attributes further comprises:
assigning, to the set of segments, a set of segment identifiers that respectively identify the set of segments; and
for each particular attribute in the multiple attributes, performing the steps of:
determining a particular segment identifier, from the set of segment identifiers, for the particular attribute; and
re-labeling as noise any occurrence of the particular attribute in any segments, of the set of segments, that are not assigned the particular segment identifier.

7. The method of claim 6, wherein determining the particular segment identifier for the particular attribute further comprises determining the particular segment identifier based on one or more intra-page constraints that are determined from the unlabeled web pages in the particular web site.

8. The method of claim 7, wherein the one or more intra-page constraints include at least one of:
a first constraint that represents attribute uniqueness among a group of attributes in the unlabeled web pages from the particular web site;
a second constraint that represents a proximity relationship among the group of attributes in the unlabeled web pages from the particular web site.

9. The method of claim 6, wherein determining the particular segment identifier for the particular attribute comprises:
determining a set of candidate identifiers for the particular attribute, wherein the set of candidate identifiers respectively identify a set of candidate segments;
computing a weight value for each candidate identifier in the set of candidate identifiers, wherein the weight value for said each candidate identifier is based on the sum of the distances from a candidate segment associated with said each candidate identifier to any other segment, in the set of candidate segments, that also includes the particular attribute; and
selecting as the particular segment identifier that one candidate identifier which has the smallest weight value of all weight values computed for the set of candidate segments.

10. The method of claim 1, wherein assigning the multiple labels to the multiple attributes further comprises:
assigning, to the set of segments, a set of segment identifiers that respectively identify the set of segments;
wherein a particular attribute of the multiple attributes is included in two or more segments that have different segment identifiers;
determining a set of candidate identifiers for the particular attribute, wherein the set of candidate identifiers respectively identify a set of candidate segments;
computing a distance between each candidate segment and any other segment in the set of candidate segments;
based on the computed distance for each candidate segment, clustering the set of candidate identifiers into multiple clusters; and
selecting one or more segment identifiers for the particular attribute from that one cluster which is associated with a minimal average weight value that is computed based on:
the number of candidate identifiers in that cluster; and
a sum of weight values for the candidate identifiers in that cluster, wherein a weight value for a candidate identifier is based on the sum of distances from a candidate segment associated with the candidate identifier to any other segment, in the set of candidate segments, that also includes the particular attribute.

11. The method of claim 1, wherein identifying the first one or more labels that were erroneously assigned comprises identifying the first one or more labels based on inter-page constraints that are determined from the unlabeled web pages in the particular web site.

12. The method of claim 11, wherein the inter-page constraints include a constraint that represents a structural similarity among the unlabeled web pages from the particular web site.

13. The method of claim 1, wherein identifying the first one or more labels that were erroneously assigned comprises:
dividing the set of segments into one or more groups of segments, wherein the segments in the same group have the same segment identifier; and
for each particular group in the one or more groups of segments, performing the steps of:
for each particular segment in said particular group, computing a minimal sequence of edit operations between said particular segment and every other segment in said particular group;
based on the minimal sequence of edit operations for each particular segment in said particular group, determining a new set of labels for a particular set of attributes, of the multiple attributes, that are included in said particular group of segments; and
comparing the new set of labels to a set of current labels that is currently assigned to the particular set of attributes in order to determine those labels in the set of current labels that were erroneously assigned.

14. The method of claim 1, wherein:
determining the second one or more labels comprises:
dividing the set of segments into one or more groups of segments, wherein the segments in the same group have the same segment identifier; and
for each particular attribute in each particular segment in each particular group of the one or more groups, performing the steps of:
determining a label which is assigned to a contiguous sequence of nodes, in said particular segment, that has a maximal count of nodes; and
selecting said label as a correct label for said particular attribute;
correcting the first one or more labels further comprises:
for each particular attribute in each particular segment in each particular group of the one or more groups, re-labeling as noise any occurrence of said particular attribute in any nodes that are not within the contiguous sequence of nodes that are associated with the correct label for said particular attribute.

15. A computer-readable storage medium storing one or more sequences of instructions which, when executed by one or more processors, cause the one or more processors to perform steps comprising:
identifying portions of repeating text in unlabeled web pages from a particular web site;
based on the portions of repeating text, partitioning the unlabeled web pages into a set of segments;
assigning, to multiple attributes in the set of segments, multiple labels that respectively correspond to the multiple attributes, wherein assigning the multiple labels comprises applying a classification model to each separate segment in the set of segments;
identifying first one or more labels that were erroneously assigned to one or more attributes in the set of segments;
determining second one or more labels that are correct for the one or more attributes in the set of segments; and
correcting the first one or more labels in the set of segments by assigning the second one or more labels to the one or more attributes.

16. The computer-readable storage medium of claim 15, wherein the one or more sequences of instructions further comprise instructions which, when executed by the one or more processors, cause the one or more processors to perform determining the classification model based on a set of annotated web pages from one or more web sites that are different than the particular web site.

17. The computer-readable storage medium of claim 16, wherein the instructions that cause the one or more processors to perform determining the classification model further comprise instructions which, when executed by the one or more processors, cause the one or more processors to perform:
identifying one or more static nodes in the set of annotated web pages;
based on the one or more static nodes, partitioning the set of annotated web pages into multiple training segments; and
deriving the classification model based on the multiple training segments, wherein the classification model comprises a set of parameter values which can be used to determine and label different attributes in page segments that are not annotated.

18. The computer-readable storage medium of claim 16, wherein the instructions that cause the one or more processors to perform determining the classification model comprise instructions which, when executed by the one or more processors, cause the one or more processors to perform determining the set of annotated web pages, wherein determining the set of annotated web pages comprises:
receiving user input that indicates one or more annotations that are associated with, and label, one or more nodes for a particular web page of the set of annotated web pages; and
using the one or more annotations to label the remaining web pages in the set of annotated web pages.

19. The computer-readable storage medium of claim 15, wherein the instructions that cause the one or more processors to perform partitioning the unlabeled web pages comprise instructions which, when executed by the one or more processors, cause the one or more processors to perform:
from the unlabeled web pages, determining static nodes that correspond to the portions of repeating text;
assigning, to the static nodes, unique identifiers that respectively identify the static nodes, wherein each unique identifier comprises the content of a corresponding node and an XPath expression that identifies the location of the corresponding node in at least one of the unlabeled web pages; and
partitioning each of the unlabeled web pages based on the unique identifiers.

20. The computer-readable storage medium of claim 15, wherein the instructions that cause the one or more processors to perform assigning the multiple labels to the multiple attributes further comprise instructions which, when executed by the one or more processors, cause the one or more processors to perform:
assigning, to the set of segments, a set of segment identifiers that respectively identify the set of segments; and
for each particular attribute in the multiple attributes, performing the steps of:
determining a particular segment identifier, from the set of segment identifiers, for the particular attribute; and
re-labeling as noise any occurrence of the particular attribute in any segments, of the set of segments, that are not assigned the particular segment identifier.

21. The computer-readable storage medium of claim 20, wherein the instructions that cause the one or more processors to perform determining the particular segment identifier for the particular attribute further comprise instructions which, when executed by the one or more processors, cause the one or more processors to perform determining the particular segment identifier based on one or more intra-page constraints that are determined from the unlabeled web pages in the particular web site.

22. The computer-readable storage medium of claim 21, wherein the one or more intra-page constraints include at least one of:
a first constraint that represents attribute uniqueness among a group of attributes in the unlabeled web pages from the particular web site;
a second constraint that represents a proximity relationship among the group of attributes in the unlabeled web pages from the particular web site.

23. The computer-readable storage medium of claim 20, wherein the instructions that cause the one or more processors to perform determining the particular segment identifier for the particular attribute comprise instructions which, when executed by the one or more processors, cause the one or more processors to perform:
determining a set of candidate identifiers for the particular attribute, wherein the set of candidate identifiers respectively identify a set of candidate segments;
computing a weight value for each candidate identifier in the set of candidate identifiers, wherein the weight value for said each candidate identifier is based on the sum of the distances from a candidate segment associated with said each candidate identifier to any other segment, in the set of candidate segments, that also includes the particular attribute; and
selecting as the particular segment identifier that one candidate identifier which has the smallest weight value of all weight values computed for the set of candidate segments.

24. The computer-readable storage medium of claim 15, wherein the instructions that cause the one or more processors to perform assigning the multiple labels to the multiple attributes further comprise instructions which, when executed by the one or more processors, cause the one or more processors to perform:
assigning, to the set of segments, a set of segment identifiers that respectively identify the set of segments;
wherein a particular attribute of the multiple attributes is included in two or more segments that have different segment identifiers;
determining a set of candidate identifiers for the particular attribute, wherein the set of candidate identifiers respectively identify a set of candidate segments;
computing a distance between each candidate segment and any other segment in the set of candidate segments;
based on the computed distance for each candidate segment, clustering the set of candidate identifiers into multiple clusters; and
selecting one or more segment identifiers for the particular attribute from that one cluster which is associated with a minimal average weight value that is computed based on:
the number of candidate identifiers in that cluster; and
a sum of weight values for the candidate identifiers in that cluster, wherein a weight value for a candidate identifier is based on the sum of distances from a candidate segment associated with the candidate identifier to any other segment, in the set of candidate segments, that also includes the particular attribute.

25. The computer-readable storage medium of claim 15, wherein the instructions that cause the one or more processors to perform identifying the first one or more labels that were erroneously assigned comprise instructions which, when executed by the one or more processors, cause the one or more processors to perform identifying the first one or more labels based on inter-page constraints that are determined from the unlabeled web pages in the particular web site.

26. The computer-readable storage medium of claim 25, wherein the inter-page constraints include a constraint that represents a structural similarity among the unlabeled web pages from the particular web site.

27. The computer-readable storage medium of claim 15, wherein the instructions that cause the one or more processors to perform identifying the first one or more labels that were erroneously assigned comprise instructions which, when executed by the one or more processors, cause the one or more processors to perform:
dividing the set of segments into one or more groups of segments, wherein the segments in the same group have the same segment identifier; and
for each particular group in the one or more groups of segments, performing the steps of:
for each particular segment in said particular group, computing a minimal sequence of edit operations between said particular segment and every other segment in said particular group;
based on the minimal sequence of edit operations for each particular segment in said particular group, determining a new set of labels for a particular set of attributes, of the multiple attributes, that are included in said particular group of segments; and
comparing the new set of labels to a set of current labels that is currently assigned to the particular set of attributes in order to determine those labels in the set of current labels that were erroneously assigned.

28. The computer-readable storage medium of claim 15, wherein:
the instructions that cause the one or more processors to perform determining the second one or more labels comprise instructions which, when executed by the one or more processors, cause the one or more processors to perform:
dividing the set of segments into one or more groups of segments, wherein the segments in the same group have the same segment identifier; and
for each particular attribute in each particular segment in each particular group of the one or more groups, performing the steps of:
determining a label which is assigned to a contiguous sequence of nodes, in said particular segment, that has a maximal count of nodes; and
selecting said label as a correct label for said particular attribute;
the instructions that cause the one or more processors to perform correcting the first one or more labels further comprise instructions which, when executed by the one or more processors, cause the one or more processors to perform:
for each particular attribute in each particular segment in each particular group of the one or more groups, re-labeling as noise any occurrence of said particular attribute in any nodes that are not within the contiguous sequence of nodes that are associated with the correct label for said particular attribute.
